(19) United States
(12) Patent Application Publication
(10) Pub. No.: US 2011/0251337 A1
(43) Pub. Date: Oct. 13, 2011

(54) BLENDS OF POLYARYLENE ETHERS AND POLYARYLENE SULFIDES COMPRISING CARBOXYLIC ANHYDRIDES

(75) Inventors: Martin Weber, Maikammer (DE); Christian Maletzko, Altrip (DE); Alexander Khvorost, Moskau (RU); Rüdiger Bluhm, Limburgerthof (DE); Susanne Zeiher, Ludwigshafen (DE)

(73) Assignee: BASF SE

(21) Appl. No.: 13/140,245

(22) PCT Filed: Dec. 8, 2009
(86) PCT No.: PCT/EP09/66584

§ 371 Date: Jun. 16, 2011

(30) Foreign Application Priority Data
Dec. 17, 2008 (EP) 08171958.5

(51) Int. Cl. C08L 71/10

(52) U.S. Cl. 524/539; 525/534

(57) ABSTRACT

The present invention relates to compositions comprising the following components:
(A) at least one polyarylene ether,
(B) at least one polyarylene sulfide, and
(C) at least one anhydride of a polybasic carboxylic acid with a number-average molar mass of at most 600 g/mol.

The present invention moreover relates to the use of the abovementioned anhydrides of polybasic carboxylic acids in compositions comprising at least one polyarylene ether and at least one polyarylene sulfide.

The present invention relates to compositions comprising the following components:
(A) at least one polyarylene ether,
(B) at least one polyarylene sulfide, and
(C) at least one anhydride of a polybasic carboxylic acid with a number-average molar mass of at most 600 g/mol.

The present invention moreover relates to the use of the abovementioned anhydrides of polybasic carboxylic acids in compositions comprising at least one polyarylene ether and at least one polyarylene sulfide.

Polyarylene ethers are members of the high-performance thermoplastics group, and their high heat resistance and high chemicals resistance make them useful in highly demanding applications, see G. Blinne, M. Knoll, D, Müller, K. Schlichting, Kunststoffe 75, 219 (1985), E. M. Koch, H.-M. Walter, Kunststoffe 80, 1146 (1990), and D. Döring, Kunststoffe 80, 1149 (1990).

Polyaryl ethers are amorphous and therefore often have insufficient resistance to aggressive solvents. Polyaryl ethers also have high melt viscosity, and this particularly impairs processing to give large moldings by injection molding. The high melt viscosity is also disadvantageous in the production of molding compositions with high loading of filler or of fiber.

EP-A 673 973 discloses that polymer mixtures composed of polyarylene ethers and polyphenylene sulfide have improved flowability and good chemicals resistance. GB-A 2 113 235 moreover discloses molding compositions which comprise not only polyphenylene sulfide but also polyarylene ethers which bear hydroxy groups. The Japanese laid-open specification JP1299872 teaches that mixtures composed of polyarylene sulfones having hydroxy end groups and polyarylene sulfides have improved properties when the sodium ion content of the polyarylene sulfide component is low.

It was an object of the present invention to provide molding compositions which do not have abovementioned disadvantages and which have high ultimate tensile strength, high modulus of elasticity, and high impact resistance, together with good processability. The molding compositions should moreover have good resistance to fuel.

The abovementioned objects are achieved via the compositions of the invention. Preferred embodiments are found in the claims and in the description below. Combinations of preferred embodiments are within the scope of the present invention.

The compositions of the invention comprise the following components:
(A) at least one polyarylene ether,
(B) at least one polyarylene sulfide, and
(C) at least one anhydride of a polybasic carboxylic acid with a number-average molar mass of at most 600 g/mol.

It is particularly preferable that the compositions of the invention comprise from 50 to 94.999% by weight of component (A), from 5 to 49.7% by weight of component (B), and from 0.001 to 0.3% by weight of component (C), in each case based on the entirety of components (B), and (C), where the total of the % by weight values for components (A), (B), and (C) is 100% by weight.

It is particularly preferable that the compositions of the invention comprise from 55 to 89.995% by weight of component (A), from 10 to 44.9% by weight of component (B), and from 0.005 to 0.1% by weight of component (C), in each case based on the entirety of components (A), (B), and (C), where the total of the % by weight values for components (A), (B), and (C) is 100% by weight.

The compositions of the present invention are preferably thermoplastic molding compositions. The individual components are explained in more detail below.

Component A

It has proven advantageous to control the end group of component (A). Polyarylene ethers usually have phenol end groups, halogen end groups, and/or ether end groups. For the present invention it is highly advantageous that component (A) has phenolic end groups to some extent.

Accordingly, component (A) preferably has at least 0.04% by weight content of phenolic end groups, particularly preferably at least 0.05% by weight, in particular at least 0.08% by weight, calculated as amount by weight of OH, based on the amount by weight of component (A).

For the purposes of the present invention, a phenolic end group is a hydroxy group bonded to an aromatic ring.

The proportion of phenolic end groups is preferably determined via potentiometric titration. For this, the polymer is dissolved in dimethylformamide, and titrated with a solution of tetrabutylammonium hydroxide in toluene/methanol. The end point is determined by potentiometry. As an alternative, the proportions of the respective end groups can be determined by ¹³C nuclear spin resonance spectroscopy.

The production of polyarylene ethers with simultaneous control of the end groups is known to the person skilled in the art and is described in more detail at a later stage below. The known polyarylene ethers usually have halogen end groups, in particular —F or —Cl, or phenolic OH end groups or phenolate end groups, and the latter can be present in unreacted or in reacted form, in particular in the form of —OCH₃ end groups.

Preferred polyarylene ethers of component (A) are composed of units of the general formula (I):

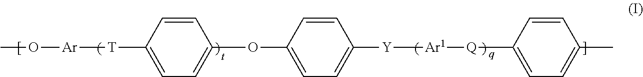

with the following definitions
t, q: independently of one another, 0, 1, 2, or 3,
Q, T, Y: in each case, independently of one another, a chemical bond or group selected from —O—, —S—, —SO₂—, S═O, C═O, —N═N—, and —CR^{a}R^{b}—, where R^{a} and R^{b}, independently of one another, are in each case a hydrogen atom or a C₁-C₁₂-alkyl, C₁-C₁₂-alkoxy, or C₆-C₁₈-aryl group, where at least one of Q, T, and Y differs from —O—, and at least one of Q, T, and Y is —SO₂—, and
Ar, Ar¹: independently of one another, an arylene group having from 6 to 18 carbon atoms.

If, among the abovementioned preconditions, Q, T, or Y is a chemical bond, this means that the group adjacent on the left-hand side and the group adjacent on the right-hand side have direct linkage to one another by way of a chemical bond.

However, it is preferable that Q, T, and Y in formula (I), independently of one another, are selected from —O— and —SO₂—, with the proviso that at least one of the group consisting of Q, T, and Y is —SO₂—.

Insofar as Q, T, or Y are —CR^{a}R^{b}—, R^{a} and R^{b}, independently of one another, are in each case a hydrogen atom or a C₁-C₁₂-alkyl, C₁-C₁₂-alkoxy, or C₆-C₁₈-aryl group.

Preferred C₁-C₁₂-alkyl groups comprise linear and branched, saturated alkyl groups having from 1 to 12 carbon atoms, and the following radicals may be given particular mention: a C₁-C₆-alkyl radical, such as methyl, ethyl, n-propyl, isopropyl, n-butyl, sec-butyl, 2- or 3-methylpentyl, and longer-chain radicals, such as unbranched heptyl, octyl, nonyl, decyl, undecyl, lauryl, and the singly or multiply branched analogs thereof.

Alkyl radicals that may be present in the abovementioned C₁-C₁₂-alkoxy groups that can be used are the alkyl groups defined above having from 1 to 12 carbon atoms. Cycloalkyl radicals that can be used with preference comprise in particular C₃-C₁₂-cycloalkyl radicals, such as cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, and cyclohexylmethyl, -dimethyl, and -trimethyl.

Ar and Ar¹ mean, independently of one another, a C₆-C₁₈-arylene group. Based on the starting materials described at a later stage below, Ar preferably derives from an electron-rich aromatic substance readily susceptible to electrophilic attack and preferably selected from the group consisting of hydroquinone, resorcinol, dihydroxynaphthalene, in particular 2,7-dihydroxynaphthalene, and 4,4′-bisphenol. Ar¹ is preferably an unsubstituted C₆- or C₁₂-arylene group.

Particular C₆-C₁₈-arylene groups Ar and Ar¹ that can be present are phenylene groups, such as 1,2-, 1,3-, and 1,4-phenylene, naphthylene groups, such as 1,6-, 1,7-, 2,6-, and 2,7-naphthylene, and also the arylene groups derived from anthracene, phenanthrene, and naphthacene.

It is preferable that Ar and Ar¹ in the preferred embodiment according to formula (I), independently of one another, are selected from the group consisting of 1,4-phenylene, 1,3-phenylene, naphthylene, in particular 2,7-dihydroxynaphthalene, and 4,4′-bisphenylene.

Units preferably present for the purposes of component (A) are those which comprise at least one of the following repeat structural units Ia to Io:

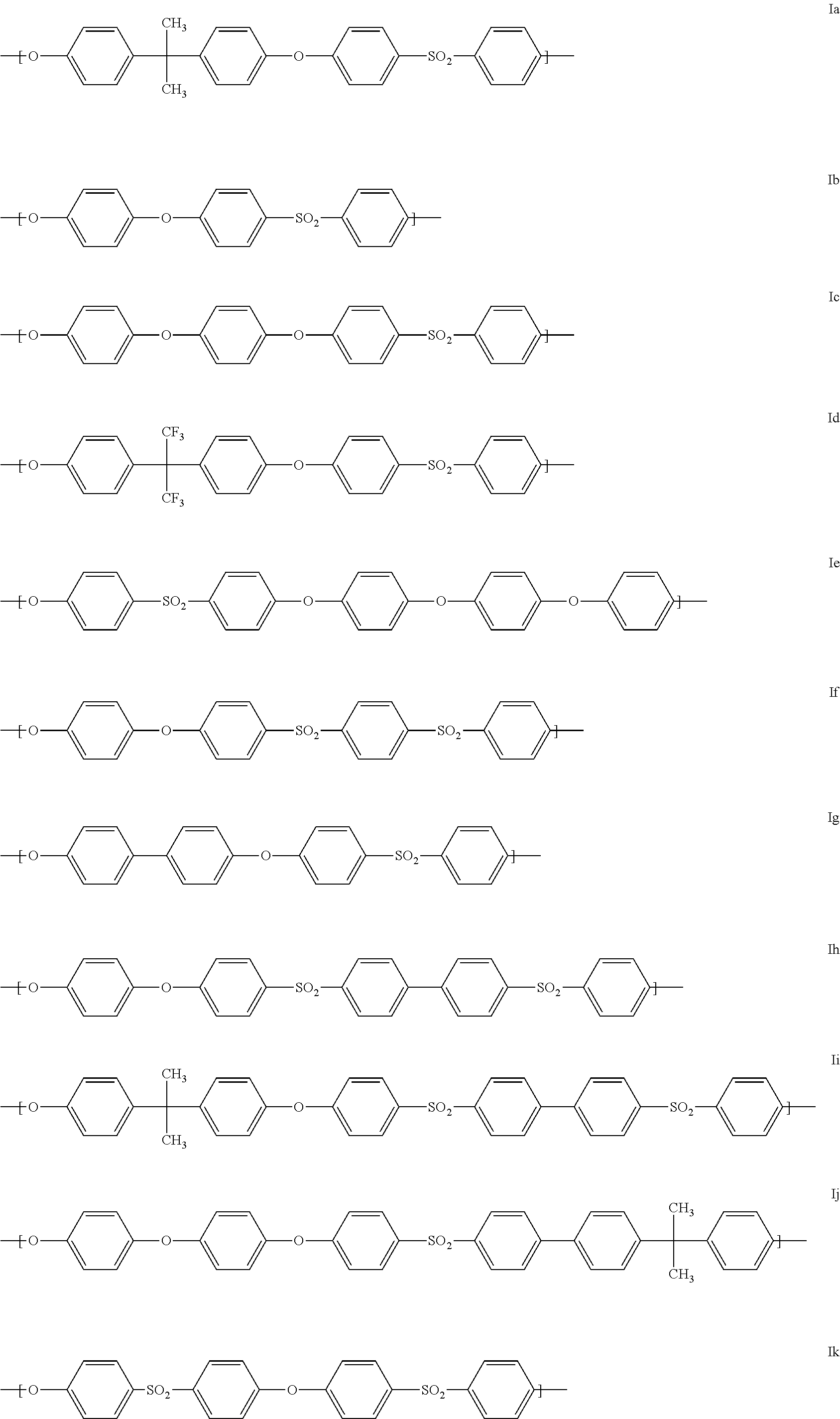

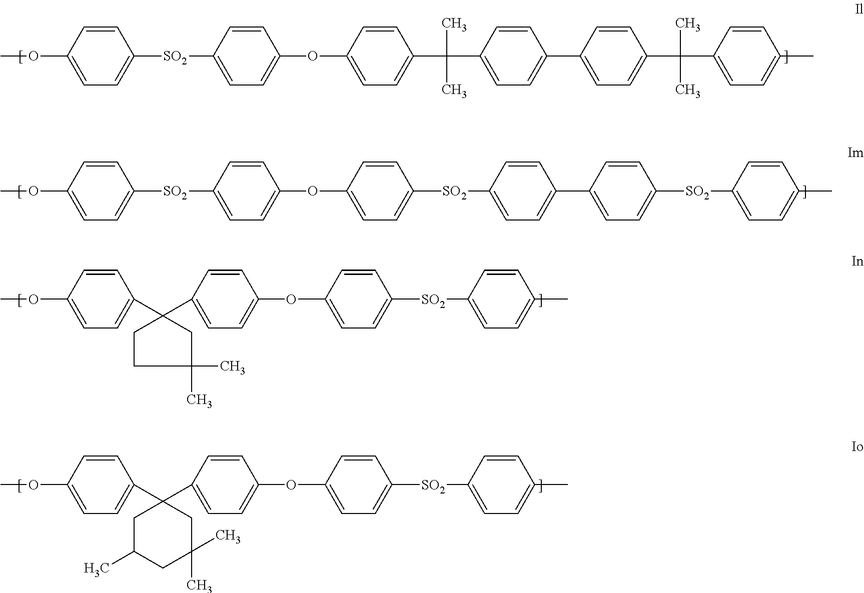

In addition to the units Ia to Io which are preferably present, preference is also given to those units in which one or more 1,4-dihydroxyphenyl units have been replaced by resorcinol units or by dihydroxynaphthalene units.

Particularly preferred units of the general formula I are the units Ia, Ig, and Ik. It is moreover particularly preferable that the polyarylene ethers of component (A) consist essentially of one type of units of the general formula I, in particular of a unit selected from Ia, Ig, and Ik.

The average molar masses Mₙ (number average) of the preferred polyarylene ethers (A) are generally in the range from 5000 to 60 000 g/mol, and their relative viscosities are generally from 0.20 to 0.95 dl/g. As a function of the solubility of the polyarylene ether sulfones, the relative viscosities are measured either in 1% strength by weight N-methylpyrrolidone solution, in mixtures composed of phenol and dichlorobenzene, or in 96% strength sulfuric acid at, respectively, 20° C. and 25° C.

The polyarylene ethers (A) of the present invention preferably have weight-average molar masses M_{w} of from 10 000 to 150 000 g/mol, in particular from 15 000 to 120 000 g/mol, particularly preferably from 18 000 to 100 000 g/mol, determined by means of gel permeation chromatography in dimethylacetamide as solvent, against narrowly distributed polymethyl methacrylate as standard.

Production processes leading to the abovementioned polyarylene ethers are known to the person skilled in the art.

The polyarylene ethers of component (A) are preferably produced via reaction of at least one aromatic compound (r1) having two halogen substituents and of at least one aromatic compound (r2) having two functional groups reactive toward abovementioned halogen substituents.

Aromatic compounds (r1) and (r2) suitable as monomers for the production of polyarylene ethers are known to the person skilled in the art and are not subject to any restriction in principle, as long as the substituents mentioned have adequate reactivity for the purposes of nucleophilic aromatic substitution. A further precondition is adequate solubility in the solvent.

Particularly suitable compounds (r1) are dihalodiphenyl sulfones, such as 4,4′-dichlorodiphenyl sulfone, 4,4′-difluorodiphenyl sulfone, 4,4′-dibromodiphenyl sulfone, bis(2-chlorophenyl)sulfones, 2,2′-dichlorodiphenyl sulfone, and 2,2′-difluorodiphenyl sulfone.

It is preferable that the aromatic compounds having two halogen substituents (r1) have been selected from 4,4′-dihalodiphenyl sulfones, in particular 4,4′-dichlorodiphenyl sulfone or 4,4′-difluorodiphenyl sulfone.

The groups reactive toward the abovementioned halogen substituents are in particular phenolic OH and 0 groups; the latter functional group derives from the dihydroxy compounds and is an intermediate arising or can be produced from this type of compound in a known manner. Preferred compounds (r2) are accordingly those having two phenolic hydroxy groups.

Preferred compounds (r2) having two phenolic hydroxy groups are selected from the following compounds:
dihydroxybenzenes, in particular hydroquinone and resorcinol;
dihydroxynaphthalenes, in particular 1,5-dihydroxynaphthalene, 1,6-dihydroxynaphthalene, 1,7-dihydroxynaphthalene, and 2,7-dihydroxynaphthalene;
dihydroxybiphenyls, in particular 4,4′-biphenol and 2,2′-biphenol;
bisphenyl ethers, in particular bis(4-hydroxyphenyl)ether and bis(2-hydroxyphenyl)ether;
bisphenylpropanes, in particular 2,2-bis(4-hydroxyphenyl)propane, 2,2-bis(3-methyl-4-hydroxyphenyl)propane, and 2,2-bis(3,5-dimethyl-4-hydroxyphenyl)propane;
bisphenylmethanes, in particular bis(4-hydroxyphenyl)methane;
bisphenyl sulfones, in particular bis(4-hydroxyphenyl)sulfone;
bisphenyl sulfides, in particular bis(4-hydroxyphenyl)sulfide;
bisphenyl ketones, in particular bis(4-hydroxyphenyl)ketone;
bisphenylhexafluoropropanes, in particular 2,2-bis(3,5-dimethyl-4-hydroxyphenyl)hexafluoropropane; and
bisphenylfluorenes, in particular 9,9-bis(4-hydroxyphenyl)fluorene.

Starting from the abovementioned aromatic dihydroxy compounds (r2), it is preferable to produce their dipotassium or disodium salts and to react these with the compound (r1). The abovementioned compounds can be used individually or in the form of a combination of two or more of the abovementioned compounds.

Particular preference is given to hydroquinone, resorcinol, and dihydroxynaphthalene, in particular 2,7-dihydroxynaphthalene, and 4,4′-bisphenol as aromatic compound (r2) having two functional groups reactive toward the halogen substituents of the aromatic compound (r1).

The quantitative proportions to be used result from the stoichiometry of the polycondensation reaction that proceeds with the calculated level of elimination of hydrogen chloride, and they are adjusted in a known manner by the person skilled in the art.

Various processes are available to the person skilled in the art for control of the number of the phenolic end groups.

By way of example, the ratio of halogen end groups to phenolic end groups can be adjusted by targeted adjustment of an excess of a dihydroxy compound during the production of the polyarylene ethers, as described at a later stage below.

The molar ratio of monomers having hydroxy functionalities to monomers having halogen functionalities is from 0.9:1.1 to 1.1:0.9, preferably from 0.95:1.05 to 1.05:0.95, particularly preferably 1:1. If various monomers having hydroxy functionalities or having halogen functionalities are present, the respective molar amounts are total.

It is particularly preferable to react the monomers in aprotic polar solvents, in the presence of anhydrous alkali metal carbonate, in particular sodium carbonate, potassium carbonate, calcium carbonate, or a mixture thereof, and very particular preference is given here to potassium carbonate, in particular potassium carbonate with volume-average particle size of less than 100 micrometers, determined in a suspension in N-methylpyrrolidone, using particle size measurement equipment. One particularly preferred combination is N-methylpyrrolidone as solvent and potassium carbonate as base.

The reaction of the suitable monomers is carried out at a temperature from 80 to 250° C., preferably from 100 to 220° C. The reaction is carried out for from 2 to 12 h, preferably from 3 to 8 h. After conclusion of the polycohdensation reaction, a monofunctional alkyl halide or monofunctional aryl halide can be added to the reaction mixture, an example being C₁-C₆-alkyl chloride, C₁-C₆-alkyl bromide, or C₁-C₆-alkyl iodide, preferably methyl chloride, or benzyl chloride, or benzyl bromide, or benzyl iodide, or a mixture thereof. Said compounds react with the hydroxy groups at the ends of the macromolecules, thus forming the terminating sections of the macromolecules.

The reaction in the melt can likewise be used. Polycondensation in the melt is carried out at a temperature of from 140 to 290° C., preferably from 150 to 280° C.

The polyarylene ether copolymers are purified by methods known to the person skilled in the art, an example being washing with suitable solvents in which the polyarylene ether copolymers of the invention are preferably substantially insoluble.

According to one preferred embodiment, it has proven advantageous that component (A) includes two different polyarylene ethers (A1) and (A2).

Accordingly, the compositions of the invention preferably comprise, as component (A), the following constituents:
(A1) at least one polyarylene ether having at most 0.01% by weight of phenolic end groups, calculated as amount by weight of OH, based on the amount by weight of component (A1), and
(A2) at least one polyarylene ether having at least 0.1% by weight of phenolic end groups, calculated as amount by weight of OH, based on the amount by weight of component (A2).

The respective upper limit for content of phenolic end groups in components (A) and, respectively, (A2) results from the number of available end groups per molecule (two in the case of linear polyarylene ethers) and from the length of the chain. Corresponding calculations are known to the person skilled in the art.

It is preferable that the proportion of phenolic end groups of component (A1) is less than 0.01% by weight of OH, based on the total amount of component (A1), in particular less than 0.001% by weight.

It is preferable that the proportion of phenolic end groups of component (A2) is at least 0.1% by weight of OH, based on the total amount of component (A2), in particular at least 0.15% by weight, particularly preferably at least 0.2% by weight.

The phenolic end groups are determined as described above, by potentiometric titration.

In one particularly preferred embodiment, component (A) is a mixture composed of the following constituents:
(A1) 75 to 99% by weight of at least one polyarylene ether having less than 0.01% by weight of phenolic end groups, calculated as parts by weight of OH, based on the amount by weight of component (A1), and
(A2) 1 to 25% by weight of at least one polyarylene ether having at least 0.1% by weight of phenolic end groups, calculated as parts by weight of OH, based on the amount by weight of component (A2).

In this preferred embodiment, component (A) is particularly preferably composed of from 80 to 98% by weight, in particular from 85 to 97% by weight, of the constituent (A1) mentioned, and of from 2 to 20% by weight, in particular from 3 to 15% by weight, of the constituent (A2) mentioned.

The polyarylene ethers (A1) and (A2) according to said preferred embodiment can—except for the end groups—be identical or composed of different units, and/or can have different molecular weight, as long as they retain complete mutual miscibility.

However, it is preferable that the constituents (A1) and (A2) have substantial structural similarity, in particular being composed of the same units, and have similar molecular weight.

One preferred process for the production of polyarylene ethers of component (A2) is described below and comprises the following steps in the sequence a-b-c:
(a) provision of at least one polyarylene ether (P) which has predominantly phenolate end groups, in the presence of a solvent (S), and is preferably composed of units of the general formula I as defined above
(b) addition of at least one acid, preferably at least one polybasic carboxylic acid, and
(c) obtaining the polyarylene ethers of component (A2) in the form of solid.

For the purposes of the present invention, phenolate end groups are negatively charged oxygen atoms in the form of an end group which have bonding to an aromatic ring. Said end groups derive from the phenolic end groups via removal of a proton. The aromatic rings mentioned are preferably 1,4-phenylene groups. The polyarylene ethers (P) of the present invention can have on the one hand phenolate end groups or phenolic OH end groups and on the other hand halogen end groups.

The expression “predominantly phenolate end groups” means that more than 50% of the end groups present are phenolate end groups. The expression “predominantly phenolic end groups” correspondingly means that more than 50% of the end groups present are of phenolic type.

The proportion of phenolate end groups is preferably determined via determination of the OH end groups by potentiometric titration, with determination of the organically bonded halogen end groups by atomic spectroscopy, and then calculation of the respective numerical proportions in %. The person skilled in the art is aware of appropriate methods. As an alternative, ¹³C nuclear spin resonance spectroscopy can be used to determine the proportions of the respective end groups.

The polyarylene ether (P) here is preferably provided in the form of a solution in the solvent (S).

Polyarylene ethers having predominantly phenolic end groups are hereinafter termed reactive polyarylene ethers.

The average molar masses Mₙ (number average) of the polyarylene ethers (P) are preferably in the range from 2000 to 60 000 g/mol, in particular from 5000 to 40 000 g/mol, determined by means of gel permeation chromatography in dimethylacetamide as solvent, against narrowly distributed polymethyl methacrylate as standard.

The relative viscosities of the polyarylene ethers (P) are preferably from 0.20 to 0.95 dl/g, in particular from 0.30 to 0.80 dl/g. The relative viscosities are determined as a function of the solubility of the polyarylene ether sulfones either in 1% strength by weight N-methylpyrrolidone solution, or in mixtures composed of phenol and dichlorobenzene, or in 96% strength sulfuric acid at respectively 20° C. and 25° C.

There are in principle various ways of providing the polyarylene ethers (P) described. By way of example, a corresponding polyarylene ether (P) can be brought directly into contact with a suitable solvent and used in the process of the invention directly, i.e. without further reaction. As an alternative, prepolymers of polyarylene ethers can be used and reacted in the presence of a solvent, giving the polyarylene ethers (P) described, in the presence of the solvent.

However, the polyarylene ether(s) (P) having predominantly phenolate end groups is preferably provided in step (a) via reaction of at least one starting compound of the structure X—Ar—Y (s1) with at least one starting compound of the structure HO—Ar¹—OH (s2) in the presence of a solvent (S) and of a base (B), where
Y is a halogen atom,
X is selected from halogen atoms and OH, and
Ar and Ar¹ are, independently of one another, an arylene group having from 6 to 18 carbon atoms.

The polyarylene ether (P) preferably has at least 60% of phenolate end groups, based on the total number of end groups, particularly preferably at least 80%, in particular at least 90%.

The ratio of (s1) and (s2) here is selected in such a way that the number of the phenolic or phenolate end groups exceeds the number of the halogen end groups.

Suitable starting compounds are known to the person skilled in the art or can be produced by known methods. Preferred starting compounds (s1) and (s2) are identical with the starting compounds (r1) and, respectively, (r2) mentioned above in the context of component (A).

Hydroquinone, resorcinol, dihydroxynaphthalene, in particular 2,7-dihydroxynaphthalene, and 4,4′-bisphenol are particularly preferred as starting compound (s2).

However, it is also possible to use trifunctional compounds. In this case, branched structures are produced. If a trifunctional starting compound (s2) is used, preference is given to 1,1,1-tris(4-hydroxyphenyl)ethane.

The quantitative proportions to be used result in principle from the stoichiometry of the polycondensation reaction that proceeds with elimination of the calculated amount of hydrogen chloride, and are adjusted in a known manner by the person skilled in the art. However, in order to increase the number of phenolic OH end groups, an excess of (s2) is preferable.

In this embodiment, it is particularly preferable that the molar ratio (s2)/(s1) is from 1.005 to 1.2, in particular from 1.01 to 1.15, very particularly preferably from 1.02 to 1.1.

As an alternative, it is also possible to use a starting compound (s1) where X=halogen and Y═OH. In this case, adjustment to an excess of hydroxy groups is achieved via addition of the starting compound (s2). The ratio of the phenolic end groups used to halogen in this case is preferably from 1.01 to 1.2, in particular from 1.03 to 1.15, very particularly preferably from 1.05 to 1.1.

Conversion in the polycondensation reaction is preferably at least 0.9, ensuring an adequately high molecular weight. If a prepolymer is used as precursor for the polyarylene ether, the degree of polymerization refers to the number of actual monomers.

Preferred solvents (S) are aprotic polar solvents. Suitable solvents moreover have a boiling point in the range from 80 to 320° C., in particular from 100 to 280° C., preferably from 150 to 250° C. Examples of suitable aprotic polar solvents are high-boiling ethers, esters, ketones, asymmetrically halogenated hydrocarbons, anisole, dimethylformamide, dimethyl sulfoxide, sulfolane, and N-methyl-2-pyrrolidone.

The starting compounds (s1) and (s2) are preferably reacted in the aprotic polar solvents (S) mentioned in particular N-methyl-2-pyrrolidone.

The person skilled in the art is aware per se that the reaction of the phenolic OH groups preferably takes place in the presence of a base (B), in order to increase reactivity with respect to the halogen substituents of the starting compound (s1).

The bases (B) are preferably anhydrous. Particularly suitable bases are anhydrous alkali metal carbonate, preferably sodium carbonate, potassium carbonate, calcium carbonate, or a mixture thereof, and very particular preference is given here to potassium carbonate, in particular potassium carbonate with volume-average particle size of less than 100 micrometers, determined in a suspension in N-methyl-2-pyrrolidone, using particle size measurement equipment.

One particularly preferred combination is N-methyl-2-pyrrolidone as solvent (S) and potassium carbonate as base (B).

The reaction of the suitable starting compounds (s1) and (s2) is carried out at a temperature of from 80 to 250° C., preferably from 100 to 220° C., and the upper limit for temperature here is determined by the boiling point of the solvent.

The reaction preferably takes place within a period of from 2 to 12 h, in particular from 3 to 8 h.

It has proven advantageous, following step (a) and prior to execution of step (b), to filter the polymer solution. This removes the salt content formed during the polycondensation reaction, and also removes any gel formed.

It has also proven advantageous in the context of step (a) to adjust the amount of the polyarylene ether (P), based on the total weight of the mixture composed of polyarylene ether (P) and solvent (S) to from 10 to 70% by weight, preferably from 15 to 50% by weight.

For the purposes of step (b), at least one acid, preferably at least one polybasic carboxylic acid, is added to the polyarylene ether (P) from step (a), preferably to the solution of the polyarylene ether (P) in the solvent (S).

“Polybasic” means a basicity of at least 2. The basicity is the (optionally average) number of COOH groups per molecule. Polybasic means that basicity is two or higher. Di- and tribasic carboxylic acids are preferred for the purposes of the present invention.

There are various ways of adding the polybasic carboxylic acid, in particular in solid or liquid form, or in the form of a solution, preferably in a solvent miscible with the solvent (S).

It is preferable that the number-average molar mass of the polybasic carboxylic acid is at most 1500 g/mol, in particular at most 1200 g/mol. At the same time, the number-average molar mass of the polybasic carboxylic acid is preferably at least 90 g/mol.

Suitable polybasic carboxylic acids are particularly those according to the general structure II:

HOOC—R—COOH (II),

where R represents a hydrocarbon radical having from 2 to 20 carbon atoms and optionally comprising further functional groups, preferably selected from OH and COOH.

Preferred polybasic carboxylic acids are C₄-C₁₀ dicarboxylic acids, in particular succinic acid, glutaric acid, adipic acid, and tricarboxylic acids, in particular citric acid.

Particularly preferred polybasic carboxylic acids are succinic acid and citric acid.

In order to ensure adequate conversion of the phenolate end groups into phenolic end groups, it has proven advantageous to adjust the amount of the polybasic carboxylic acid(s) used, based on the amount of the phenolate end groups.

For the purposes of step (b), it is preferable that the amount added of a polybasic carboxylic acid corresponds to an amount of from 25 to 200 mol % of carboxy groups, preferably from 50 to 150 mol % of carboxy groups, particularly preferably from 75 to 125 mol % of carboxy groups, based on the molar amount of phenolate end groups or phenolic end groups.

If the amount of acid added is too small, the precipitation performance of the polymer solution is inadequate, whereas if the amount added is markedly too great the product can become discolored during further processing.

The molar amount of phenolate end groups or phenolic end groups is determined on the one hand by potentiometric titration of the phenolic OH groups, and the organically bonded halogen end groups are determined on the other hand by atomic spectroscopy, and the person skilled in the art uses this data to determine the number-average molecular weight and the molar amount of phenolate end groups or phenolic end groups present.

In step (c), the polyarylene ether (A2) is obtained in the form of solid.

In principle, various processes can be used for obtaining the material as solid. However, preference is given to obtaining the polymer composition via precipitation.

The preferred precipitation can in particular take place via mixing of the solvent (S) with a poor solvent (S′). A poor solvent is a solvent which does not dissolve the polymer composition. This poor solvent is preferably a mixture composed of a nonsolvent and of a solvent. A preferred nonsolvent is water. A preferred mixture (S′) composed of a solvent with a nonsolvent is preferably a mixture composed of the solvent (S), in particular N-methyl-4-pyrrolidone, and water. It is preferable that the polymer solution from step (b) is added to the poor solvent (S′), and this precipitates the polymer composition. It is preferable to use an excess of the poor solvent here. It is particularly preferable that the polymer solution from step (a) is added in finely divided form, in particular in droplet form.

If a mixture composed of the solvent (S), in particular N-methyl-2-pyrrolidone, and of a nonsolvent, in particular water, is used as poor solvent (S′), a preferable mixing ratio of solvent to nonsolvent is from 1:2 to 1:100, in particular from 1:3 to 1:50.

Preferred poor solvent (S′) is a mixture composed of water and N-methyl-2-pyrrolidone (NMP), in combination with N-methyl-2-pyrrolidone as solvent (S). An NMP/water mixture in a ratio of from 1:3 to 1:50, in particular 1:30, is particularly preferred as poor solvent (S′).

The precipitation is particularly efficient when the content of the polymer composition in the solvent (S), based on the total weight of the mixture composed of polymer composition and solvent (S), is from 10 to 50% by weight, preferably from 15 to 35% by weight.

The potassium content of component (A2) is preferably at most 600 ppm. Potassium content is determined by atomic spectroscopy.

Component B

The molding compositions of the invention comprise, as component (B), at least one polyarylene sulfide. In principle, any of the polyarylene sulfides can be used as component (B).

The polyarylene sulfides of component (B) preferably comprise from 30 to 100% by weight of repeat units according to the general formula —Ar—S—, where —Ar— is an arylene group having from 6 to 18 carbon atoms.

Preference is given to polyarylene sulfides which comprise at least 30% by weight, in particular at least 70% by weight, of repeat units (III):

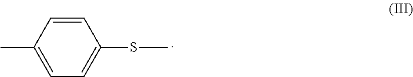

Examples of other suitable repeat units are

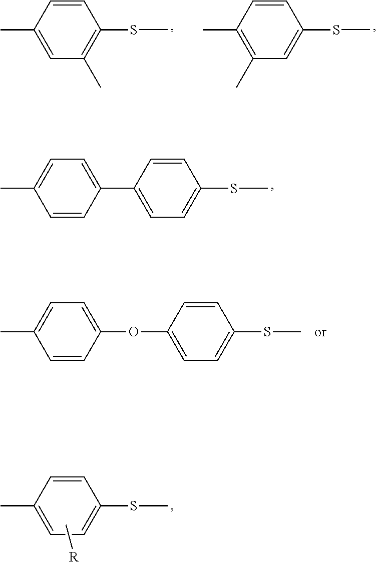

in which R is C₁-C₁₀-alkyl, preferably methyl. The polyarylene sulfides can be either random copolymers or else block copolymers. Very particularly preferred polyarylene sulfides comprise 100 mol % of units of the general formula (III). It is therefore particularly preferable that component (B) is a polyphenylene sulfide, in particular poly(1,4-phenylene sulfide).

Examples of end groups that can be used are halogen, thiol, or hydroxy, preferably halogen.

The polyarylene sulfides can be branched or unbranched. The preferred polyarylene sulfides have weight-average molar masses of from 1000 to 1 000 000 g/mol.

These polyarylene sulfides are known per se or obtainable by known methods. By way of example, they can, as described in US 2,513,188, be produced via reaction of haloaromatic compounds with sulfur or with metal sulfides. It is equally possible to heat metal salts of halogen-substituted thiophenols (see GB-B 962 941). Among the preferred syntheses of polyarylene sulfides is the reaction of alkali metal sulfides with haloaromatic compounds in solution, as found by way of example in U.S. Pat. No. 3,354,129. Other processes are described in U.S. Pat. No. 3,699,087, U.S. Pat. No. 4,645,826 and J. P. Critchley et al., “Heat Resistant Polymers”, pages 151 to 160 (1983), Plenum Press, New York.

Component C

The compositions of the invention comprise at least one anhydride of a polybasic carboxylic acid with number-average molar mass of at most 600 g/mol, preferably from 90 g/mol to 500 g/mol, in particular from 90 g/mol to 400 g/mol.

The compositions of the invention are obtainable via addition of at least one anhydride of a polybasic carboxylic acid with number-average molar mass of at most 600 g/mol, preferably from 90 g/mol to 500 g/mol, in particular from 90 g/mol to 400 g/mol, to components (A) and (B), as described above.

Preferred anhydrides (C) have low volatility and low toxicity and are ideally non-toxic.

It is obvious to the person skilled in the art that the anhydrides used are reactive toward the phenolic end groups in component (A) or (B) and therefore are not present, or not entirely present, as anhydride in the compositions of the invention, but instead are present entirely or to some extent in reacted form.

However, the form in which the anhydrides of component (C) are present in the compositions of the invention is not a form incorporated into a polymer chain, or a grafted form or other copolymeric form, but instead that of additives which can be present after reaction with reactive end groups. A distinction is therefore made between the anhydrides used according to the invention and polymers and/or copolymers comprising copolymerized anhydrides.

The basicity is the (if appropriate average) number of COOH groups per molecule.

Polybasic means that the functionality is two or higher. Anhydrides preferred for the purposes of the present invention are those whose structure is based on a carboxylic acid basicity of 2 or 3.

Component (C) is preferably composed of at least one anhydride of a polybasic carboxylic acid according to the general structure IV:

HOOC—R—COOH (IV),

where R represents a linear or branched hydrocarbon radical having 2 to 20 carbon atoms and optionally comprising further functional groups, preferably selected from OH and COOH, with the proviso that the polybasic carboxylic acids can form an anhydride, preferably a cyclic anhydride, in particular where at least two COOH groups have linkage to one another by way of 2 or 3 carbon atoms.

Preference is therefore likewise given to cycloaliphatic dicarboxylic anhydrides, in particular 1,2-cyclohexanedicarboxylic anhydride. Preferred anhydrides based on cycloaliphatic dicarboxylic acids have the following structure (V):

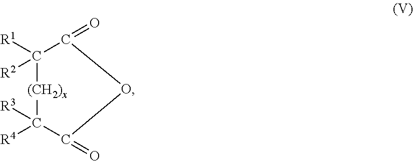

where R¹ to R⁴, independently of one another, are selected from H and from linear or branched alkyl chains having from 1 to 10 carbon atoms, preferably H, and x=0 or 1.

Particularly preferred anhydrides are C₄-C₁₀ aliphatic dicarboxylic anhydrides. Preferred carboxylic anhydrides are: succinic anhydride, alkylsuccinic anhydrides, phthalic anhydride, trimellitic anhydrides, tetrahydrophthalic anhydride, hexahydrophthalic anhydride, 5-norbornene-2,3-dicarboxylic anhydride, norbornanecarboxylic anhydride, and glutaric anhydride. Particular preference is given to succinic anhydride, glutaric anhydride, and adipic anhydride.

Besides these, it is also possible per se to use compounds which comprise dicarboxylic anhydrides and comprise ethylenically unsaturated groups, an example being maleic anhydride. However, it is preferable to use anhydrides which have no reactive double bonds.

Very particular preference is given to succinic anhydride as component (C).

Component D

In one preferred embodiment of the present invention, the compositions of the invention comprise, as further component (D), at least one filler, the amount of which is preferably from 5 to 250 parts by weight and particularly preferably from 20 to 100 parts by weight of component (D), based on 100 parts by weight of components (A), (B), and (C).

The molding compositions of the invention can in particular comprise particulate or fibrous additives.

Preferred fibrous fillers or fibrous reinforcing materials are carbon fibers, potassium titanate whisker, aramid fibers, and particularly preferably glass fibers. When glass fibers are used, these can have been equipped with a size, preferably a polymethane size, and with a coupling agent, to improve compatibility with the matrix material. The diameter of the carbon fibers and glass fibers used is generally in the range from 6 to 20 μm.

Component (D) is preferably composed of glass fibers.

The glass fibers can be incorporated either in the form of short glass fibers or else in the form of continuous-filament strands (rovings). The average length of the glass fibers in the finished injection molding is preferably in the range from 0.08 to 0.5 mm.

Carbon fibers or glass fibers can also be used in the form of wovens, mats, or glass silk rovings.

Suitable particulate fillers are amorphous silica, carbonates, such as magnesium carbonate (chalk), powdered quartz, mica, a very wide variety of silicates, such as clays, muscovite, biotite, suzoite, tin maletite, talc, chlorite, phlogophite, feldspar, calcium silicates, such as wollastonite, or aluminum silicates, such as kaolin, particularly calcined kaolin.

According to one particularly preferred embodiment, particulate fillers are used and the diameter (largest dimension) of at least 95% by weight of the particles, preferably at least 98% by weight, determined on the finished product, is less than 45 μm, preferably less than 40 μm, their “aspect ratio” being in the range from 1 to 25, preferably in the range from 2 to 20, determined on the finished product.

An example of a method for determining the particle diameters here takes electron micrographs of thin sections of the polymer mixture and uses at least 25, preferably at least 50, filler particles for evaluation, The particle diameters can equally be determined by way of sedimentation analysis, according to Transactions of ASAE, page 491 (1983). The proportion by weight of the fillers below 40 μm can also be measured by a sieve analysis. The aspect ratio is the ratio of particle diameter to thickness (largest dimension to smallest dimension).

Particulate fillers used with particular preference are talc, kaolin, such as calcined kaolin, or wollastonite, or a mixture composed of two or of all of said fillers. Among these, particular preference is given to talc having a proportion of at least 95% by weight of particles with diameter smaller than 40 μm, and with an aspect ratio of from 1.5 to 25, determined in each case on the finished product. Kaolin preferably has a proportion of at least 95% by weight of particles with diameter smaller than 20 μm, and preferably has an aspect ratio of from 1.2 to 20, determined in each case on the finished product.

The compositions can moreover comprise further components E.

Component E

The molding compositions of the invention can comprise, as further component (E), auxiliaries, in particular processing aids, pigments, stabilizers, flame retardants, or a mixture of various additives. Other examples of conventional additives are oxidation retarders, agents to counteract decomposition by heat and decomposition by ultraviolet light, lubricants and mold-release agents, dyes and plasticizers.

The proportion of component (E) in the molding composition of the invention is in particular from 0 up to 30% by weight, preferably from 0 to 20% by weight, in particular from 0 to 15% by weight, based on the total weight of components A to E. If component E includes stabilizers, the proportion of said stabilizers is usually up to 2% by weight, preferably from 0.01 to 1% by weight, in particular from 0.01 to 0.5% by weight, based on the total of the % by weight values for components (A) to (E).

The amounts generally comprised of pigments and dyes are from 0 to 6% by weight, preferably from 0.05 to 5% by weight, and in particular from 0.1 to 3% by weight, based on the total of the % by weight values for components (A) to (E).

Pigments for the coloring of thermoplastics are well known, see for example R. Gachter and H. Müller, Taschenbuch der Kunststoffadditive [Plastics additives handbook], Carl Hanser Verlag, 1983, pages 494 to 510. A first preferred group of pigments that may be mentioned are white pigments, such as zinc oxide, zinc sulfide, white lead [2 PbCO₃.Pb(OH)₂], lithopones, antimony white, and titanium dioxide. Of the two most familiar crystalline forms of titanium dioxide (rutile and anatase), it is in particular the rutile form which is used for white coloring of the molding compositions of the invention. Black color pigments which can be used according to the invention are iron oxide black (Fe₃O₄), spinell black [Cu(Cr, Fe)₂O₄], manganese black (a mixture composed of manganese dioxide, silicon dioxide, and iron oxide), cobalt black, and antimony black, and also particularly preferably carbon black, which is mostly used in the form of furnace black or gas black. In this connection see G. Benzing, Pigmente fur Anstrichmittel [Pigments for paints], Expert-Verlag (1988), pages 78 ff.

According to the invention, particular color shades can be achieved by using inorganic chromatic pigments, such as chromium oxide green, or organic chromatic pigments, such as azo pigments or phthalocyanines. Pigments of this type are generally commercially available. Examples of oxidation retarders and heat stabilizers which can be added to the thermoplastic compositions according to the invention are halides of metals of group I of the Periodic Table of the Elements, e.g. sodium halides, potassium halides, or lithium halides, examples being chlorides, bromides, or iodides. Zinc fluoride and zinc chloride can moreover be used. It is also possible to use sterically hindered phenols, hydroquinones, substituted representatives of said group, secondary aromatic amines, optionally in combination with phosphorus-containing acids, or to use their salts, or a mixture of said compounds, preferably in concentrations up to 1% by weight, based on the total of the % by weight values for components (A) to (E).

Examples of UV stabilizers are various substituted resorcinols, salicylates, benzotriazoles, and benzophenones, the amounts generally used of these being up to 2% by weight.

Lubricants and mold-release agents, the amounts of which added are generally up to 1% by weight, based on the total of the % by weight values for components (A) to (E), are stearyl alcohol, alkyl stearates, and stearamides, and also esters of pentaerythritol with long-chain fatty acids. It is also possible to use dialkyl ketones, such as distearyl ketone.

The molding compositions of the invention comprise, as preferred constituent, from 0.1 to 2% by weight, preferably from 0.1 to 1.75% by weight, particularly preferably from 0.1 to 1.5% by weight, and in particular from 0.1 to 0.9% by weight (based on the total of the % by weight values for components (A) to (E)) of stearic acid and/or stearates. Other stearic acid derivatives can in principle also be used, examples being esters of stearic acid.

Stearic acid is preferably produced via hydrolysis of fats. The products thus obtained are usually mixtures composed of stearic acid and palmitic acid. These products therefore have a wide softening range, for example from 50 to 70° C., as a function of the constitution of the product. Preference is given to products with more than 20% by weight content of stearic acid, particularly preferably more than 25% by weight. It is also possible to use pure stearic acid (>98%).

Component (E) can moreover also include stearates. Stearates can be produced either via reaction of corresponding sodium salts with metal salt solutions (e.g. CaCl₂, MgCl₂, aluminum salts) or via direct reaction of the fatty acid with metal hydroxide (see for example Baerlocher Additives, 2005). It is preferable to use aluminum tristearate.

Further additives that can be used are also those known as nucleating agents, an example being talc.

Production of compositions

Components (A) to (E) can be mixed in any desired sequence.

The molding compositions of the invention can be produced by processes known per se, for example extrusion. The molding compositions of the invention can by way of example be produced by mixing the starting components in conventional mixing apparatuses, such as screw-based extruders, preferably twin-screw extruders, Brabender mixers, or Banbury mixers, or else kneaders, and then extruding them. The extrudate is cooled and comminuted. The sequence of the mixing of the components can be varied, and it is therefore possible to mix two or, if appropriate, three components in advance, but it is also possible to mix all of the components together.

In order to obtain a mixture with maximum homogeneity, intensive and thorough mixing is advantageous. Average mixing times needed for this are generally from 0.2 to 30 minutes at temperatures of from 280 to 380° C., preferably from 290 to 370° C. The extrudate is generally cooled and comminuted.

The molding compositions of the invention feature good mechanical properties, and, in comparison with the prior art, improved flowability, and improved stress-cracking resistance.

The molding compositions of the invention feature good flowability together with improved toughness, especially tensile strain at break and notched impact resistance.

The molding compositions of the invention are therefore suitable for the production of moldings for household items, or electrical or electronic components, and also for moldings for the vehicle sector.

The thermoplastic molding compositions of the invention can advantageously be used for the production of moldings.

The present invention further provides the use of anhydrides of polybasic carboxylic acids as described for the purposes of component (C) in compositions comprising at least one polyarylene ether and at least one polyarylene sulfide, preferably for increasing stiffness, or for increasing tensile strain at break, or for improving impact resistance.

The examples below provide further explanation of the invention, without restricting the same.

### EXAMPLES

The moduli of elasticity and the tensile strain at break of the specimens were determined in the ISO 527 tensile test on dumbbell specimens.

The impact resistance of the products was determined on ISO specimens to ISO 179 1eU.

Flowability was assessed on the basis of melt viscosity. Melt stability was determined by means of a capillary rheometer. The apparent viscosity was determined here at 350° C. as a function of shear rate. The values stated were determined as 1000 Hz.

Stress-cracking resistance was determined to DIN EN ISO 22088-3 on test specimens of thickness 2 mm. The test fluid was allowed to act for various periods at 1.32% flexural strain, and the condition of the test specimen was then assessed visually.

Resistance to fuel was determined by exposure to FAM B fuel at 80° C. for 7 days.

The condition of the specimens was then assessed visually:

+: unchanged

+/−: slight surface alteration, no discernible cracks

−: severe surface alteration, clearly discernible cracks −−: fracture of specimen

The altered sites were studied for cracks under an optical microscope.

Component A

A polyether sulfone with viscosity number of 55.4 ml/g (Ultrason® E 2010 from BASF SE) was used as component A-1. The product used had 0.16% by weight of Cl end groups and 0.21% by weight of OCH₃ end groups. The OH end groups were below the detectable limit.

A polyether sulfone with viscosity number of 55.6 ml/g was used as component A-2, and had 0.20% by weight of OH end groups and 0.02% by weight of CI end groups.

Component B

A polyphenylene sulfide with melt viscosity of 145 Pa*s at 330° C. at a shear rate of 1000 Hz was used as component B-1.

Component C

Succinic anhydride was used as component C-1.

Component D

Chopped glass fibers with staple length 4.5 mm and fiber diameter 10 μm were used as component D-1 and had been provided with a polyurethane size.

TABLE 1

| Example | comp1 | comp2 | comp3 | 4 | 5 | 6 | 7 | 8 |
|---|---|---|---|---|---|---|---|---|
| Comp. A-1 | 70 | 41 | 36 | 36 | 36 | 30 | 33 | 36 |
| Comp. B-1 | | 14 | 14 | 13.99 | 13.995 | 19.99 | 11.99 | 13.85 |
| Comp. A-2 | | | 5 | 5 | 5 | 5 | 5 | 5 |
| Comp. C-1 | | | | 0.01 | 0.005 | 0.01 | 0.01 | 0.15 |
| Comp. D-1 | 30 | 45 | 45 | 45 | 45 | 45 | 50 | 45 |
| Modulus of | 9.40 | 16.5 | 16.4 | 16.5 | 16.5 | 17.2 | 18.9 | 16.4 |
| elasticity [GPa] | | | | | | | | |
| Tensile strain | 2.4 | 1.4 | 1.6 | 1.8 | 1.8 | 1.7 | 1.6 | 1.3 |
| at break [%] | | | | | | | | |
| ISO 179 1eU | 48 | 41 | 43 | 47 | 46 | 44 | 42 | 37 |
| [kJ/m²] | | | | | | | | |
| Viscosity at | 690 | 551 | 563 | 560 | 565 | 491 | 625 | 564 |
| 10³ Hz [350° C.] | | | | | | | | |
| Resistance to | +/− | + | + | + | + | + | + | + |
| FAM B at 25° C. | | | | | | | | |

The constitutions are stated in parts by weight.

The molding compositions of the invention feature a combination of high stiffness, good toughness, low viscosity, and good resistance to fuel.

1-16. (canceled)

17. A composition comprising the following components:
(A) at least one polyarylene ether,
(B) at least one polyarylene sulfide, and
(C) at least one anhydride of a polybasic carboxylic acid with a number-average molar mass of at most 600 g/mol,
wherein component (A) comprises the following constituents:
(A1) at least one polyarylene ether having at most 0.01% by weight of phenolic end groups, calculated as amount by weight of OH, based on the amount by weight of component (Al), and
(A2) at least one polyarylene ether having at least 0.1% by weight of phenolic end groups, calculated as amount by weight of OH, based on the amount by weight of component (A2).

18. The composition according to claim 17, wherein component (A) has at least 0.04% by weight content of phenolic end groups, calculated as amount by weight of OH, based on the amount by weight of component (A).

19. The composition according to claim 17, wherein the polyarylene ethers of component (A2) are obtainable via a process which comprises the following steps in the sequence a-b-c:
(a) provision of at least one polyarylene ether (P) which has predominantly phenolate end groups, in the presence of a solvent (S),
(b) addition of at least one polybasic carboxylic acid, and
(c) obtaining the polyarylene ethers of component (A2) in the form of solid.

20. The composition according to claim 17, wherein the polyarylene ethers of component (A) are composed of units of the general formula I: 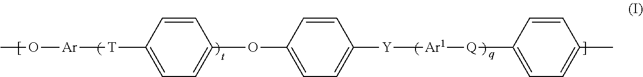
wherein
t and q, independently of one another, is 0, 1, 2, or 3,
Q, T and Y, in each case, independently of one another, is a chemical bond or group selected from —O—, —S—, —SO₂—, S═O, C═O, —N═N—, and —CR^{a}R^{b}—, wherein R^{a} and R^{b}, independently of one another, are in each case is a hydrogen atom or a C₁-C₁₂-alkyl, C₁-C₁₂-alkoxy, or C₆-C₁₈-aryl group, wherein at least one of Q, T, and Y differs from —O—, and at least one of Q, T, and Y is —SO₂—, and
Ar, Arⁱ, independently of one another, is a C₆-C₁₈-arylene group.

21. The composition according to claim 20, where Q, T, and Y in formula (I), independently of one another, is selected from —O— and —SO₂—, and at least one of Q, T, and Y is —SO₂—.

22. The composition according to claim 20, where Ar and Ar¹ in formula (I), independently of one another, is selected from the group consisting of 1,4-phenylene, 1,3-phenylene, naphthylene, and 4,4’-bisphenylene.

23. The composition according to claim 17, comprising from 50 to 94.999% by weight of component (A), from 5 to 49.7% by weight of component (B), and from 0.001 to 0.3% by weight of component (C), wherein the total of the % by weight values for components (A), (B), and (C) is 100% by weight.

24. The composition according to claim 17, wherein the polyarylene sulfides of component (B) are composed of from 30 to 100% by weight of repeat units according to the general formula —Ar—S—, where —Ar— is an arylene group having from 6 to 18 carbon atoms.

25. The composition according to claim 17, wherein component (B) is polyphenylene sulfide, preferably poly(1,4-phenylene sulfide).

26. The composition according to claim 17, wherein component (C) is composed of at least one anhydride of a polybasic carboxylic acid according to the general structure IV:
HOOC—R—COOH (IV),
wherein R represents a linear or branched hydrocarbon radical having from 2 to 20 carbon atoms and optionally comprising further functional groups, preferably selected from OH and COOH, with the proviso that at least two COOH groups of each polybasic carboxylic acid have bonding to one another by way of two or three carbon atoms.

27. The composition according to claim 17, wherein component (C) is succinic anhydride.

28. The composition according to claim 17 comprising, as further component (D), at least one filler.

29. The composition according to claim 28 comprising from 5 to 250 parts by weight of component (D), based on 100 parts by weight of the mixture composed of components (A), (B), and (C).

30. The composition according to claim 28, wherein component (D) is composed of glass fibers.

31. A method for increasing the stiffness, for increasing the tensile strain at break or for improving impact resistance, the method comprising:
utilizing anhydrides of polybasic carboxylic acids as defined in claim 17 in compositions comprising at least one polyarylene ether and at least one polyarylene sulfide.
